(19) United States
(12) Patent Application Publication
(10) Pub. No.: US 2009/0007250 A1
(43) Pub. Date: Jan. 1, 2009

(54) Client authentication distributor

(75) Inventors: Dominic J. Pouzin, Sammamish, WA (US); Michael James Lu, Seattle, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/823,386

(22) Filed: Jun. 27, 2007

(51) Int. Cl. H04L 9/32

(52) U.S. Cl. 726/10

(57) ABSTRACT

The claimed method and system provides a client authentication distributor component (CAD) that handles multiple client application requests for authentication to a common authentication provider. In one embodiment, only a single user sign on process may be required after which the CAD manages future authentication processes on behalf of the user without the user requiring to provide credentials.

### BACKGROUND

Generally, client applications may need to authenticate to a remote server to operate. In some situations multiple applications may need to authenticate to a common authentication provider. Existing computer operating systems may accommodate multiple authentication requests for the same authentication provider by initiating a new authentication session with the authentication provider for each authentication request received from a client application. Each authentication session may require that a user provide user credentials, such as a user login and password, to authenticate to the authentication provider. Because a user may open multiple applications or multiple instances of the same application (all of which require authentication to the common authentication provider), a user may need to provide the same user credentials (e.g., user login and password) multiple times during a computing session. This may be cumbersome and inefficient.

### SUMMARY

The claimed method and system provides a client authentication distributor component (CAD) that handles single or multiple client application requests for authentication to a common authentication provider. The CAD may be responsible for collecting client credentials for use in maintaining an authentication state. The CAD may provide indications of an authentication state, a connection state or change in an authentication state or connection state. As multiple applications or multiple application instances request authentication to the common authentication provider, the CAD may provide a local client authentication service in place of the authentication provider after an initial authentication process.

### DRAWINGS

FIG. 1 illustrates a computing system including a plurality of client computers and server computers;

FIG. 2 illustrates a system implementing a general authentication process;

FIG. 3 may illustrate an existing process for authentication a client application requesting access to server application;

FIG. 4 illustrates an embodiment of a system using a client authentication distributor (CAD) to manage an authentication state of a computing device;

FIG. 5 illustrates an embodiment of a client authentication distributor;

FIG. 6 illustrates a client process portion of a client authentication distributor system;

FIG. 7 illustrates an embodiment of an authentication state renewal process;

FIG. 8 illustrates a sign off process that may be used with an authentication client; and

FIG. 9 illustrates a sign off process that may be used in an embodiment of a client authentication distributor.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

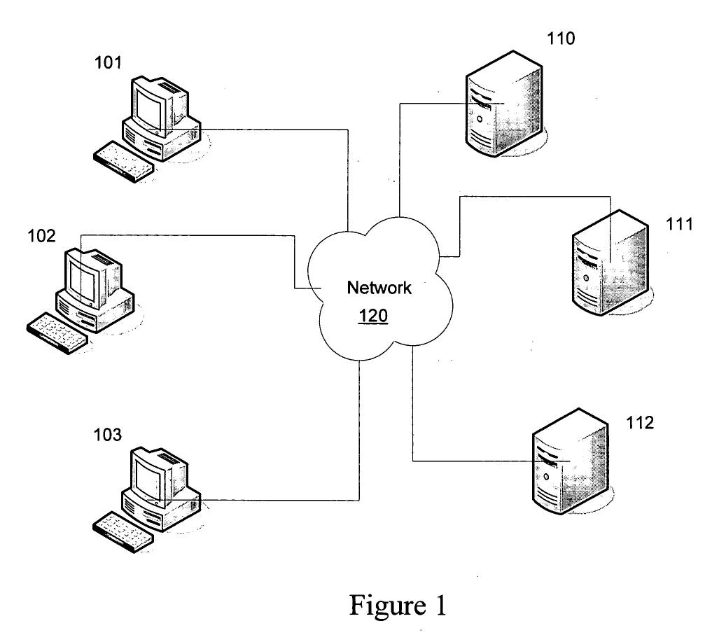

FIG. 1 illustrates a general computing environment in which a plurality of client computers 101-103 are networked to one or more servers 111-113 via a network 120. One or more client computers 101-103 may require access to at least one of the servers 111-113. In some cases, a client computer may be programmed to run a client application that requires data or a service provided by one of the servers 111-113. The servers 111-113 may be programmed to run one or more server applications that provide data or a service to a requesting client 101-103. In some situations, the data stored and provided by servers 111-113 may need to be secured so that only a certain set of client computers 101-103 or a certain set of users (not shown) using client computers 101-103 may be able to access the data. This security need may also apply to services provided by the servers (e.g., ability to modify employee data). Thus, the servers 111-113 may employ an authentication service that requires user credentials. The authentication service may be provided by each one of servers 111-113 or one server 111-113 may provide the authentication service for another server 111-113 or for a server application residing on one of servers 111-113.

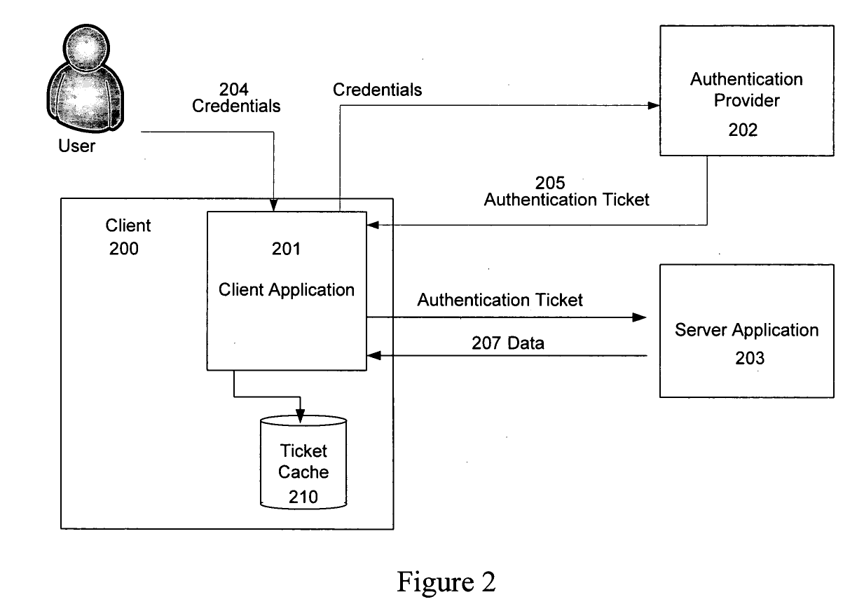

FIG. 2 illustrates an implementation of an existing authentication system. A client 200 may run a client application 201 may require authentication from an authentication provider 202 to access a server application 203. Generally, the application 201 may prompt a user for user credentials 204 for a specific authentication provider 202 and pass these credentials to the authentication provider 202. After verifying the credentials of the user, the authentication provider may provide or return an authentication state 205 to the client application 201. The authentication state 205 may take the form of an authentication ticket. In one embodiment, the authentication ticket may be a signed hash of an identifier of the user and a timestamp. The authentication ticket 205 may be used to communicate with a target application server that provides services/data 207 to the client application 201. In the system described in FIG. 2, the authentication provider may provide an authentication service to the server application 203. The server application 203 may represent a server machine or an application running on a server machine. In one embodiment, a server machine may run more than a single server application 203, where one or more applications is serviced by a different authentication provider. It should be noted that while the authentication provider 202 and the server application 203 are illustrated as being run on two separate devices, the authentication provider and the server application may be run on the same server machine or provided by a common server application program.

The authentication ticket may be cached in a data store 210 for future use. For example, when the client application 201 needs to access the server application 203 multiple times, the client application 201 may send the authentication ticket or a copy of the authentication ticket in cache 210 when accessing the server application 203. Generally, the authentication ticket may have an expiration time after which the authentication ticket is no longer valid. For example, upon expiration of the authentication ticket, the client application may not be able to access the server application using the authentication ticket. At expiration, the client application may need to again request user credentials that the client application may again pass to the authentication provider 202 to obtain a renewed authentication ticket.

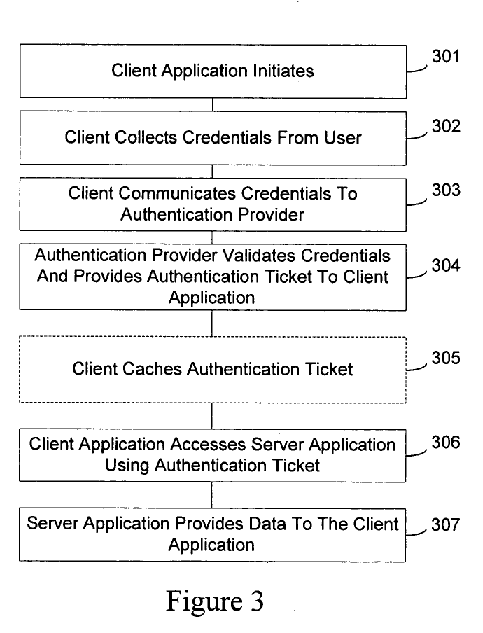

FIG. 3 may illustrate an existing process for authenticating a client application 201 requesting access to server application 203. When the client application is started 301 (or when the client application initiates a function requiring access to a server application requiring authentication), the client application may collect user credentials for a user 302. The client may then initiate a sign on process with an authentication provider and communicate the credentials 303. The authentication provider may then validate the credentials and provide an authentication state (e.g., an authentication ticket) 304. The client may optionally (as represented by the dashed line boxed) cache the authentication ticket. This may be the case when a client application may need to access the server application multiple different times. After obtaining an authentication state/ticket from the authentication provider, the client may then access the server application by presenting the authentication ticket 306. The server application may then provide data and/or fulfill service requests for the client application 307.

Generally, the authentication ticket may be specific for a particular application, where the authentication ticket may only be used by that application. Thus, when a second application requires access to a server (e.g., 203), the second application must undergo the same process described above in FIG. 3 to obtain an authentication ticket specific to the second application. In some systems, the authentication ticket may be specific to a particular instance of an application. Thus, when a second instance of the application needs access to server 203, the second instance may also need to separately and independently undergo the same authentication process described above to obtain a separate authentication ticket. Therefore, in existing client authentication processes, a user of a computer having multiple applications (or multiple instances of applications) that require access to a common server resource may need to provide user credentials multiple times to operate or continue to operate the applications.

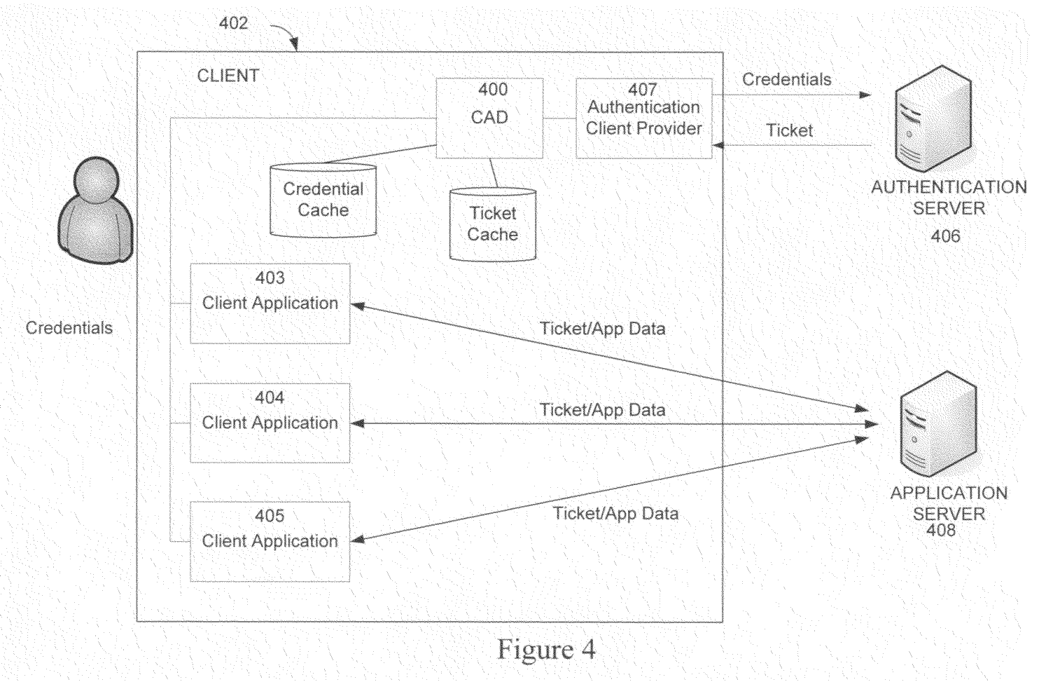

FIG. 4 illustrates an embodiment of a system using a client authentication distributor (CAD) 400 to manage an authentication state of a client computing device 402. The computing device 402 may run a plurality of client applications 403-405 that require authentication from an authentication server 406 to access a server application 408. Instead of directly communicating with an authentication provider 406, a first client application 403 may communicate with the CAD 400 to obtain authentication information from the authentication client provider 407 that communicates with authentication server 406. This may include obtaining an authentication state indicating whether the CAD is authenticated or not authenticated to authentication server 406 via the authentication client provider 407. The authentication state provider 407 may be a component that interfaces with a particular authentication server based on an existing client device configuration. For example, if client device is connected to a secure intranet (e.g., a secure corporate network), then the CAD may select an authentication client provider that works with Active Directory. If the client device 402 is connected outside the intranet, then the CAD may select an authentication client provider that uses cookie based authentication. Factors which may be used to re-determine an appropriate authentication client provider may be detected changes in IP address, recovery from hibernation, etc. If the CAD 400 is authenticated to the authentication provider 407 and authentication server 406, an authentication state may include a valid authentication ticket for access to server application 408. In one embodiment, the CAD 400 may act as an authentication provider to a client application 403-405 in place of authentication provider 406.

In one embodiment, a single CAD 400 may manage all authentication requests for a single authentication provider. The CAD 400 may provide credentials to an authentication provider 406 and receive an authentication state (e.g., an authentication ticket) from the authentication provider 406. If there are multiple authentication providers, a separate CAD may exist for each authentication provider. In one embodiment, a plurality of authentication providers may be managed by a single CAD. In this embodiment, a single CAD may keep track of the authentication clients for each authentication provider that the single CAD manages.

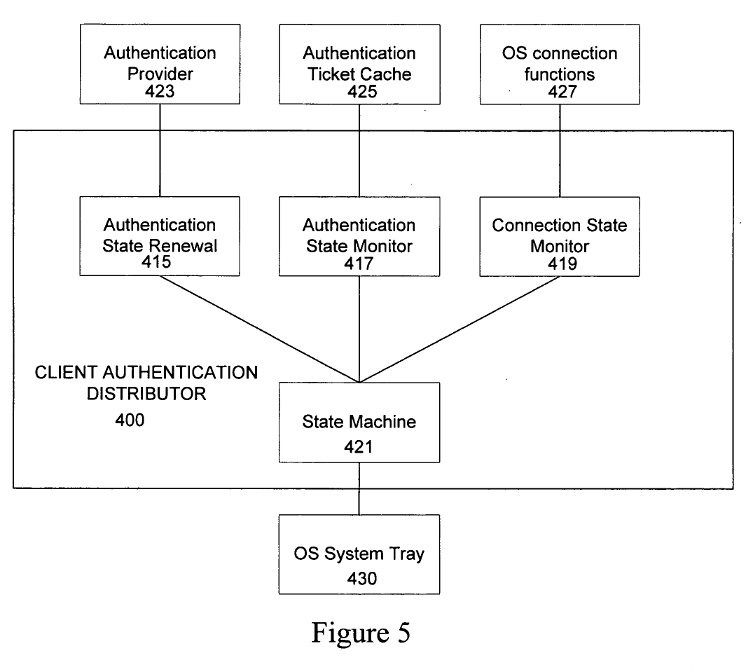

As illustrated in FIG. 5, CAD 400 may include a number of functional components 415, 417, 419, and 421. Authentication state renewal component 415 may function to communicate with an authentication provider 423 to obtain an authentication ticket using user credentials. These credentials may be cached in a public storage space (e.g., persisted) or maintained via a running instance or thread of the CAD (without being cached in a public accessible storage space).

Authentication state monitor 417 may monitor authentication expiration or check authentication state. For example, the authentication state monitor 417 may attempt to access a server using an authentication ticket to determine whether the authentication ticket is valid. Alternatively, the authentication state monitor may periodically check an authentication ticket expiration time (which may be indicated on the ticket or may be a duration provided by the authentication server) against a current time. The authentication ticket may be stored in an authentication ticket cache 425. The authentication state monitor 417 may determine that an authentication state is valid if the authentication ticket is not expired. The authentication state monitor 417 may determine that an authentication state is due if the authentication ticket is about to expire (based on a predetermined or preset time to expire). The authentication state monitor 417 may determine that an authentication state is expired if a current time is past the authentication ticket expiration time. The authentication state monitor 417 may determine that an authentication state is lost if the CAD cannot locate or obtain a previously referenced authentication ticket.

Connection state monitor 419 may periodically check whether a valid connection to an authentication provider and/or a target application server (e.g., an application server associated with the authentication provider) exist. In one embodiment, the connection state monitor may leverage or use existing operating system functions 427 or network functions (e.g., by calling the operating system functions) to check the state of a connection. Alternatively, the connection state monitor may determine connection status or state by attempting to connect to authentication provider 423 or to an application server. The connection state monitor 419 may determine that a connection is lost when the connection state monitor 419 is not able to establish communication between the client and a server. The connection state monitor may determine that a connection is valid or invalid based on whether the client is able to communicate with the server (e.g., even after a communication is established).

The CAD 400 may also include a state machine 421 that may function to provide indications to an application, operating system, or user. The indications may include displaying a state of a connection, an authentication state, and/or changes in connection state or authentication state, as described above. In one embodiment, the state machine 421 may communicate with an operating system status bar 430, such as a Windows system tray. In this embodiment, the state machine 421 may use popup balloons, icons, or windows that emanate or appear to emanate from the system tray to display the indication. The indication may produce a popup balloon when a state change happens. The indication may produce an indication of an authentication state and/or connection state when a user performs an action requesting the indication (e.g., when the user places a mouse pointer over an icon representing the state machine in the system tray).

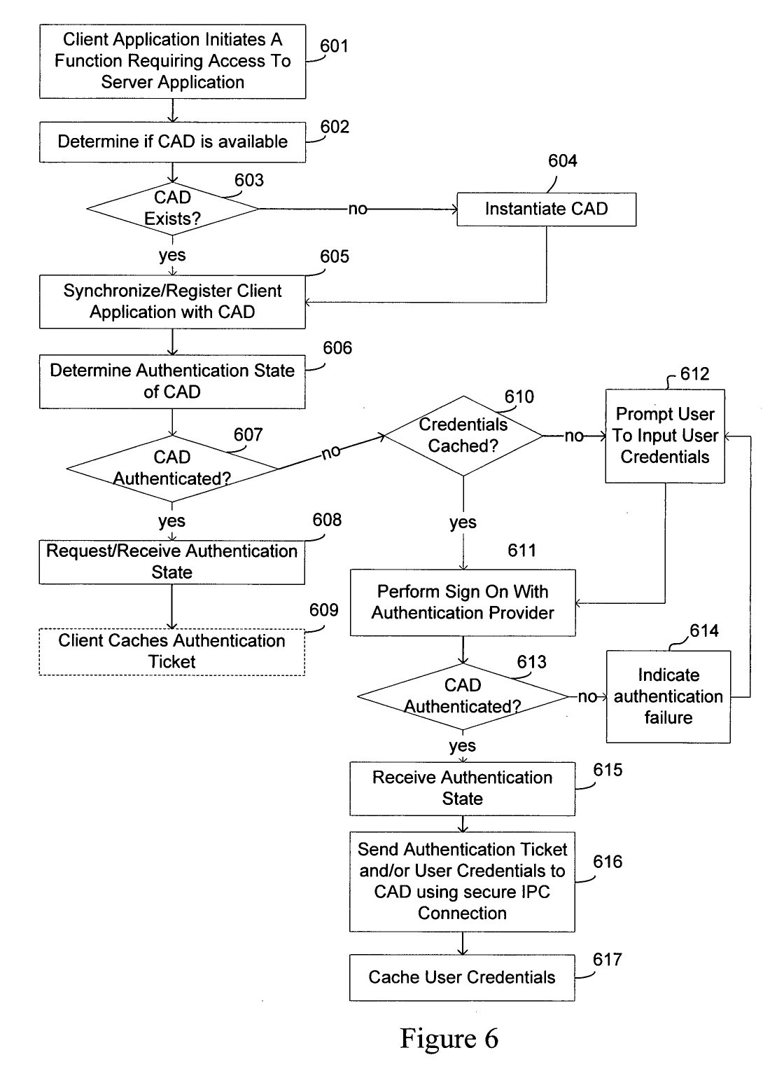

FIG. 6 illustrates a client portion of a client authentication distributor system. When a client application initiates a function requiring access to a server application (or when a client application that requires access to a server application is initiated or started 401) 601, the client may first determine whether an existing CAD is available for an authentication provider 602. This determination may be performed, for example, by checking an operating system for existing instances of a CAD for the authentication provider (e.g., using an operating system registry). In one embodiment, instead of an operating system registry, other registry type methods may be used. For example, a named Kernel object, process or event may be used to provide a mapping of existing CAD objects. If there is no existing CAD 603, then a new CAD may be instantiated 604.

If there is an existing CAD instance 603, then the client application may synchronize or register with the CAD 605. This may entail providing information to the CAD for listing the client as an authentication client for a particular authentication provider and/or a particular server application requiring authentication. The client application may then begin communicating with the CAD instance to elicit authentication information 606. The client application may establish a secure channel with the CAD to query the CAD for its authentication state with an authentication provider. Generally, the authentication provider may provide an authentication service for a server application that the client application may access. If the CAD is authenticated 607, the CAD may provide an authentication state to the client application 608. The authentication state may be an authentication ticket, which may be optionally cached 609.

If the CAD is not authenticated to the appropriate authentication provider 607, the client may initiate an authentication process with the CAD. If user credentials relating to the server application (and the authentication provider for the server application) are cached 610, the client application may perform a silent sign in process that does not require user involvement (e.g., the process may not require the user to enter a login or password, or the process may not indicate to the user that a sign in is being performed) 611. If user credentials have not been cached 610, the client process may display a sign in form to collect or correct user credentials 612. Alternatively, if the sign in fails 613, an indication of the failed sign on process may be generated 614 and the client process may again display a sign in form to collect or correct user credentials 612.

If the credentials are properly authenticated 613, an authentication state may be obtained 615, otherwise the client application may not be able to access the server application. Obtaining an authentication state may involve possession of a valid authentication ticket that may be used to access a target server application. For example, upon obtaining the authentication ticket, the client application may then proceed to initiate communication with the server application. The client application may first send the authentication ticket to the server application to begin communication with the server application. In one embodiment, the authentication ticket may be required each time access to the server application is initiated by the client application.

In one embodiment, the authentication state (e.g., authentication ticket) may be managed by the client authentication distributor. Once the client application obtains an authentication state from an authentication provider for a server application, the client may establish a secure channel (e.g., an ICP channel) with the client authentication distributor. The client application may then provide the authentication state to the client authentication distributor via the secure channel 616. In addition to the authentication state, the client application may provide the user credentials used to obtain the authentication state to the client authentication distributor.

In one embodiment, the user credentials may be cached at the client device for access by the client application 617. In one embodiment, the user credentials are not cached and after the authentication state and the user credentials are communicated to the client authentication distributor, the user credentials are no longer persisted or accessible by the client application.

A cache, such as a cookie cache, may be used to store the authentication state (e.g., authentication ticket). As described above, after the authentication state is obtained by the client from the above process, the client application may store the authentication state in the cache 609. Each time the client application needs to communicate with the server application, the client application may send the authentication state (from the cache) with its access request to the server application.

After a first client application initiates the above process for obtaining an authentication state from the authentication provider for the target server application, a second client application requiring access to the same server application may easily obtain the authentication state from the client authentication provider without needing another sign on process. In particular, the second client application may start the process illustrated in FIG. 6, and proceed to block 608 without requiring the process after block 610. Specifically, because the CAD is initiated and has an authentication state, the CAD may simply provide the client application with the valid authentication ticket for the same server application and the second client application may then be able to communicate with the server application. In this case, as illustrated in FIG. 6, the client application may not need to communicate with an authentication provider (e.g., authentication provider 406) to access a server application (e.g., server application 408).

The CAD may be configured to maintain the authentication state. In particular, the CAD may be programmed to renew the authentication state. The renewal may be performed in a preemptive manner to prevent the authentication state from expiring. In one embodiment, the CAD may use the authentication state monitor 417 to periodically determine the status of the authentication state. For example, the authentication state may expire after a duration of time. The authentication state monitor may keep track of the expiration time for an authentication ticket. The authentication state monitor may then compare a current time with the expiration of the authentication ticket. The authentication state monitor may provide an indication of a time to expiration (e.g., indicating a duration between the expiration time and a current time) to the authentication state renewal component 415.

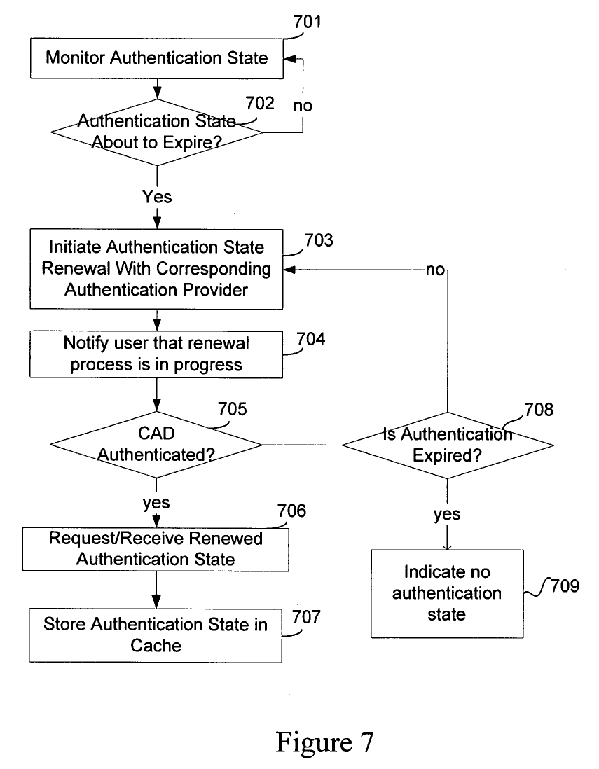

The authentication state renewal component may be programmed to renew an authentication state or ticket as illustrated in the embodiment of FIG. 7. The CAD may use the authentication monitor to check a time of expiration of the authentication state 701. Based on the time to expiration provided by the authentication state monitor, if the authentication state is about to expire 702, the authentication state renewal component may initiate a renewal process with an authentication provider of the authentication ticket 703. Optionally, an indication that a renewal is in process may be displayed 704. If a renewed authentication state is received 706, which may be in the form of a renewed authentication ticket, the authentication state may be placed in an authentication cache 707.

In one embodiment, the CAD may compare the time to expiration to a predetermined time to expiration and initiate authentication state renewal if the actual time to expiration is less than the predetermined time to expiration. The authentication renewal may be initiated by communicating an authentication ticket (e.g., one that is about to expire) and/or a set of credentials corresponding to the authentication ticket. In one embodiment, the set of credentials may be maintained by an instance or thread of the CAD. For example, the credentials may be maintained by the authentication state renewal component. Because the credentials are stored in a running program memory of the CAD component instance, they may not be accessible to a user or other program (different from the CAD). In an alternative embodiment, the credentials may be stored or persisted in a credential cache, which may be public to the client computer. In this case, the credentials may be accessed by the user or another client application. If the credentials are cached, the CAD may access the credentials directly from the cache or the CAD may request the credentials from the client application, and the client application may in turn retrieve the credentials from the cache and supply the credentials to the CAD. In one embodiment, if the credentials are cached by the client application, the CAD may not directly access the credentials and therefore, the CAD may be programmed to always request the credentials from the client application when needed by the CAD for the renewal process. In one embodiment, the authentication state cache may be managed primarily by the CAD and may not be directly accessible by other programs. In this embodiment, access to the authentication ticket may be via the CAD. Thus, in this embodiment, any time a client application needs to use the authentication ticket, the client application may request it from the CAD. The determination of whether credentials are cached may be made by a user and/or operating system of the client computer.

After communicating an authenticated ticket and/or credentials to the authentication provider in block 703, the authentication provider may renew the authentication state 703. If the authentication state is renewed 705, the authentication provider, may issue a renewed ticket 706 which is then stored in the authentication state cache 707. If the authentication state is not renewed 705, the CAD may then determine whether the authentication state is expired 708. If the authentication state is still valid, then the CAD may re-attempt to renew the authentication state 703. The authentication state may not have been renewed for a number of reasons, including a connection loss, a server unavailable issue, or other factors. If authentication is determined to be expired, then the CAD may provide a notification of the expiration 709.

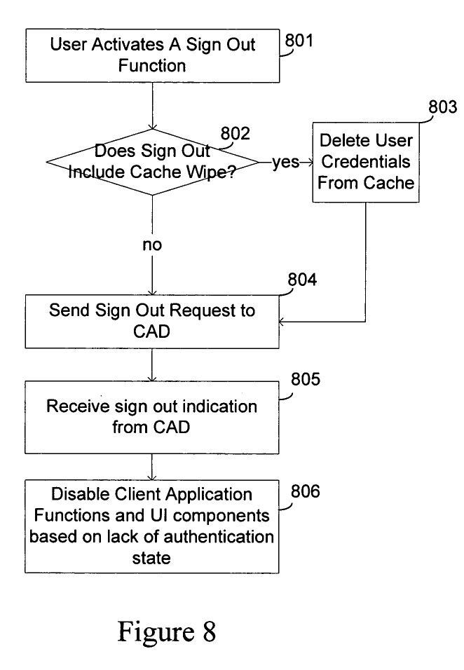

FIG. 8 illustrates a sign off process that may be used in an embodiment. A user may activate a sign out or sign off to a server application 801. If the user or client device caches credentials (e.g., publicly), then a regular “sign off” may not automatically delete the cached credentials. If the client application provides a “sign off and forget” option 802, the sign off may include deleting cached user credentials 803. The client may then send a request to the CAD to initiate a sign off with an authentication provider corresponding to the client 804. After the sign off process is finished, the client may receive an indication that the signoff is complete 805, and the client may take necessary actions based on the signoff indication, such as disabling functionality that requires authentication 806.

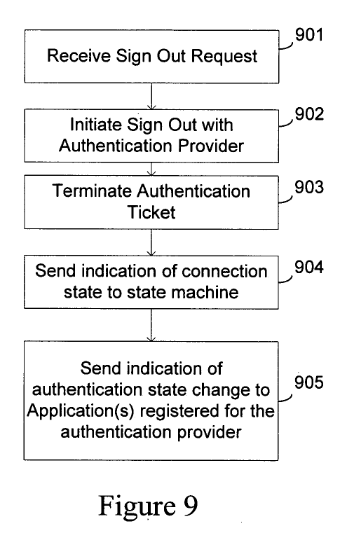

FIG. 9 illustrates a sign off process at the CAD. The CAD may receive a sign off request from a client 901. The CAD may then communicate with an authentication state provider corresponding to the client request to initiate a sign off 902. The sign off may include terminating an authentication ticket 903. After the sign off process is initiated or performed, the CAD may provide an indication that the CAD (or the client computer) no longer has authentication state with the server application 904. This indication may be provided to a user and/or an operating system via the state machine.

A sign out indication may also be provided to each client application 905. The CAD may use a registry to determine all client applications registered for a common authentication provider and perform the indication based on the registry. In one embodiment, known Kernel objects, events, or processes may be used to provide mappings to applications. It should be noted that a user may initiate the sign off while using a first client application that is authenticated by a common authentication provider via the CAD. A second client application may also be using the same authentication ticket as the first client application. When the user signs off from the first client application, the second client application may be notified by the CAD that there is no longer an authentication state for the common authentication provider. The second application, if still running, may then disable certain functions requiring access to the server application authenticated by the authentication provider. If the user intends to continue using the second application, the client may require a user to provide user credentials.

In one embodiment, the functionality described above for a client application may be isolated and incorporated into a client interface component. In this embodiment, the interface component may provide a common set of functions to enable a separate client application to use the client authentication distributor. The set of functions that may be incorporated into the client interface may be summarized as follows:

Start CAD if not already running;

Synchronize with an established CAD during client application initialization;

Query the CAD to determine authentication state;

Obtain credentials from a user using a login form (e.g., using a secure cache);

Verify credentials by signing on and obtaining an authentication state with an authentication provider;

Report authentication failures to a user; Send verified credentials along with an authentication state to the CAD over a secure IPC connection;

Request the CAD to maintain authentication state using the credentials;

Provide or enable menu items including “sign out” and/or “sign out and forget me” functions;

Request that a sign out action be performed by the CAD when a corresponding menu item (e.g., “sign out” or “sign out and forget me”) is activated; and

Receive sign out notifications from the CAD and optionally disable functionality (such as UI functionality) of a client application based on the sign out notification.

It should be noted that the above described CAD may be hosted out of process as well as loaded in process. In other words in one embodiment, the CAD process may be loaded in shared or resident mode (e.g., shared memory) in which the CAD may be publicly accessed by any process having access to the shared process. In another embodiment, the CAD may be loaded in process or hosted inside a process. In this embodiment, the CAD may be isolated from or non-accessible to some other processes. This may be intentionally done to provide isolation from other processes.

The above described method and system of using a client authentication distributor generally enables more efficient operation of a client computing device by a user when the computing device is running a single application that is started and stopped multiple times or running a plurality of applications requiring authentication from a common authentication provider. Instead of requiring multiple sign on operations by the user for each application or requiring multiple sign on operations each time the same application is stopped and started, the described method and system allows a user to sign on a single time, for example when initiating a first client application for the common authentication provider, without the need to perform any further sign on processes. Moreover, because authentication states may expire after a set period of time, the described method and system may also prevent a user from having to periodically sign on (after an initial sign on process) to maintain an authentication state. Instead, the claimed method and system manages a periodic renewal process that may be preemptive of authentication state expiration. Moreover, the described client authentication distributor system may maintain a list of authentication clients (e.g., client applications) for a particular authentication provider. After a sign out process is initiated or performed, the described CAD may notify all registered authentication clients so that each client may react appropriately (e.g., by disabling application functionality). Moreover, the described process provides a notification system using a state machine. As discussed above, the state machine may be used with an operating system tray (or operating system monitoring bar) to provide instant notification to a user of state changes.

In one embodiment, the above described method may be implemented in a Microsoft Outlook and CRM server system. In this embodiment, the client interface described above may be implemented as a Microsoft Outlook plugin for providing Outlook clients with the CAD client functionality. The CRM server may represent a server providing the CRM server application which may need to be accessed by the Outlook clients. In this embodiment, the authentication server may be a Microsoft Passport server. The CAD may receive authentication requests from an Outlook client (via the plugin) and maintain an authentication state (e.g., using a passport ticket) with the Passport server for allowing access by the Outlook client to the CRM server application. In this embodiment, the authentication tickets may be stored in an Internet Explorer cookie store that is accessible to the Outlook client.

What is claimed:

1. A method of managing client requests for authentication from an authentication provider comprising:
receiving a client authentication request from a first client for a first authentication provider at a client authentication distributor (CAD);
determining a first authentication state between the client authentication distributor (CAD) and the first authentication provider, wherein if the CAD is authenticated to the first authentication provider, the CAD provides to the first client a reference to an authentication ticket for communication with a first server authenticated by the first authentication provider;
and if the CAD is not authenticated to the first authentication provider, determining whether first credentials for the first authentication provider are cached, and if the first credentials are cached, performing a sign in with the first authentication provider using the cached first credentials, and if the first credentials are not cached, receiving credentials from a user for the first authentication provider and performing a login with the first authentication provider using the received credentials for the first authentication provider.

2. The method of claim 1, further comprising caching the credentials received from the user and periodically renewing, before expiration of the ticket, the authentication state with the first authentication provider using the cached credentials, thereby generating a renewed ticket.

3. The method of claim 1, further comprising maintaining the credentials in running program memory of the CAD and periodically renewing, before expiration of the ticket, the authentication state with the first authentication provider using the credentials in the CAD running program memory, thereby generating a renewed ticket.

4. The method of claim 1, wherein the credentials are received from the first client using a secure channel.

5. The method of claim 1, wherein the CAD periodically monitors at least one of a connection state and an authentication state.

6. The method of claim 5, wherein authentication state is monitored by checking the expiration of each ticket against a current time.

7. The method of claim 6, wherein the period of monitoring is adapted based on the state of the first client.

8. The method of claim 5, wherein a thread used to monitor connection state is placed in a sleep or hibernation state when the first client is offline and wherein the thread used to monitor connection state is run at an accelerated rate when the first client comes online or transitions out of a hibernation or sleep state.

9. The method of claim 5, further comprising generating notification events wherein the notification events comprise at least one of a current connection state, a current authentication state, or a state change.

10. The method of claim 9, wherein the notification events are received by a process for the first client that displays a status message based on the notification event.

11. The method of claim 1, further comprising receiving a client authentication request from a second client for the first authentication provider.

12. The method of claim 11, wherein a notification event is transmitted from the CAD to the first and second client indicating at least one of an authentication state, a connection state, or a state change.

13. The method of claim 1, further comprising receiving a second client authentication request for a second authentication provider at the client authentication distributor (CAD),
determining a second authentication state between the client authentication distributor (CAD) and the second authentication provider, wherein if the CAD is authenticated to the second authentication provider, the CAD provides to the client a reference to a second authentication ticket for communication with a server authenticated by the second authentication provider;
and if the CAD is not authenticated to the second authentication provider, determining whether second credentials for the second authentication provider are cached, and if the second credentials are cached, performing a sign in with the second authentication provider using the cached second credentials, and if the second credentials are not cached, receiving credentials for the second authentication provider from a user and performing a login with the first authentication provider using the received credentials for the second authentication provider.

14. A system of managing authentication state for a plurality of clients comprising:
a first client application;
a second client application;
a first authentication provider providing an authentication service for a first server application.
a client authentication distributor (CAD) that receives an authentication request from at least one of the first and second client application for the first authentication provider and provides a first authentication ticket to the at least one of the first and second client application if the CAD is authenticated by the first authentication provider, otherwise the CAD determines whether client credentials for the first authentication provider are cached, and if the client credentials for the first authentication provider are cached, performing a login process with the first authentication provider and providing a first generated authentication ticket to the at least one of the first and second client application.

15. The system of claim 14, wherein the first client application, the second client application, and the CAD are run on a first computing device.

16. The system of claim 14, further comprising a third client application, a fourth client application, and a second authentication provider providing an authentication service for a second server application,
wherein the CAD receives authentication requests from at least one of the third and fourth client application for the second authentication provider and provides a second authentication ticket to the at least one of the third and fourth client application if the client authentication distributor is authenticated by the second authentication provider, otherwise the CAD determines whether client credentials for the second authentication provider are cached, and if the client credentials for the second authentication provider are cached, performing a login process with the second authentication provider and providing a second generated authentication ticket to the at least one of the third and fourth client application.

17. A computing apparatus comprising:
a display unit that is capable of generating video images;
an input device;
a processing apparatus operatively coupled to the display unit and the input device, the processing apparatus comprising a processor and a memory operatively coupled to the processor;
a network interface connected to a network and to the processing apparatus;
the processing apparatus being programmed to:
run a first client application requiring access to a first server application;
run a second client application requiring access to the first server application;
receive an authentication request from the first and second client application for a first authentication provider and if an authentication ticket exists in a cache providing authentication to the first authentication provider, providing the cached ticket to the first and second client application, otherwise, determining whether client credentials for the first authentication provider are cached, and if the client credentials are cached, performing a login process with the first authentication provider and providing an authentication ticket generated by the login process to the first and second client application.

18. The computing apparatus of claim 17, wherein the processing apparatus is further programmed to display on the display unit an indication of at least one of a connection state, an authentication state, or a state change.

19. The computer apparatus of claim 17, wherein the processing apparatus is further programmed to maintain credential information in a running program memory of a client authentication distributor instance.

20. The computer apparatus of claim 19, wherein the processing apparatus is further programmed to renew authentication state using the cached credentials or, if the credentials are not cached, using the credential information in running program memory.
